(19) United States
(12) Patent Application Publication
(10) Pub. No.: US 2025/0249732 A1
(43) Pub. Date: Aug. 7, 2025

(54) SUNROOF DEVICE

(71) Applicant: AISIN (SUZHOU) TECHNICAL CENTER CO., LTD., Suzhou (CN)

(72) Inventors: Ryuta FUKADA, Suzhou (CN); Jiefeng ZHANG, Suzhou (CN)

(73) Assignee: AISIN (SUZHOU) TECHNICAL CENTER CO., LTD., Suzhou (CN)

(21) Appl. No.: 18/969,515

(22) Filed: Dec. 5, 2024

(30) Foreign Application Priority Data
Feb. 1, 2024 (CN) 202420253105.7

(51) Int. Cl. B60J 7/00; B60J 7/043

(52) U.S. Cl. CPC B60J 7/0084; B60J 7/043

(57) ABSTRACT

A sunroof device includes: a pair of guide rails, which extend along a front-rear direction of a vehicle and are respectively arranged on both sides of the sunroof opening in a vehicle width direction; a panel drainage component, which extends in the vehicle width direction and traverses the sunroof opening; and a pair of drainage members, which are respectively mounted on the pair of guide rails, and are respectively located below two end portions of the panel drainage component in the vehicle width direction, the panel drainage component is provided with a panel drainage groove extending in the vehicle width direction, each of the guide rails is provided with only one guide rail drainage groove extending in the front-rear direction, and the drainage member is configured such that water flowing out of the panel drainage groove is guided into the guide rail drainage groove via the drainage member.

### FIELD OF THE DISCLOSURE

The present disclosure relates to a sunroof device, and in particular, to a drainage structure in the sunroof device.

### BACKGROUND

In the existing sunroof device of a vehicle, there are: a pair of guide rails, which extend along a front-rear direction of the vehicle and are respectively arranged on both sides of a sunroof opening in a vehicle width direction; and a panel drainage component, which extends in the vehicle width direction and traverses the sunroof opening. The panel drainage component is provided with a panel drainage groove extending in the vehicle width direction. Each guide rail is provided with a first drainage groove and a second drainage groove extending in the front-rear direction and arranged side by side in the vehicle width direction. The first drainage groove is used to drain water on the guide rail out of the vehicle. The second drainage groove is located below the two ends of the panel drainage component in the vehicle width direction, and water flows directly from the panel drainage groove into the second drainage groove, and is discharged outside the vehicle by guiding by the second drainage groove.

However, in the above sunroof device, two drainage grooves need to be provided on the guide rail for the drainage of the sunroof panel and the drainage of the guide rail respectively. As a result, a cross section of the guide rail becomes complex, and the manufacturing cost becomes high. In addition, it is necessary to occupy space on the side of the sunroof opening to set the second drainage groove. Therefore, the area of the sunroof opening becomes smaller, and the commercial quality of the sunroof device becomes worse.

### SUMMARY

The present disclosure is completed in view of the above problems, and an objective of the present disclosure is to provide a sunroof device that can miniaturize the guide rail and increase the area of the sunroof opening.

The present disclosure relates to a sunroof device, including: a pair of guide rails, which extend along a front-rear direction of a vehicle and are respectively arranged on both sides of a sunroof opening in a vehicle width direction; a panel drainage component, which extends in the vehicle width direction and traverses the sunroof opening; and a pair of drainage members, which are respectively mounted on the pair of guide rails, and are respectively located below two end portions of the panel drainage component in the vehicle width direction. The panel drainage component is provided with a panel drainage groove extending in the vehicle width direction. Each of the guide rails is provided with only one guide rail drainage groove extending in the front-rear direction. The drainage member is configured such that water flowing out of the panel drainage groove is guided into the guide rail drainage groove via the drainage member.

According to the above structure, only one guide rail drainage groove is provided on the guide rail, and water flowing out of the panel drainage groove of the panel drainage component is guided into the above guide rail drainage groove via a separately provided drainage member, thereby achieving drainage of the guide rail and drainage of the sunroof panel at the same time. Compared with a case in which two drainage grooves, namely, a drainage groove for guide rail drainage and a drainage groove for panel drainage for receiving water from the panel drainage component, are provided on the guide rail, the cross-sectional structure of the guide rail can be simplified, the dimension of the guide rail in the vehicle width direction can be reduced, and the manufacturing cost of the guide rail can be reduced, and the area of the sunroof opening can be increased, so that the commercial quality of the sunroof device is improved.

In addition, in the present disclosure, preferably, the guide rail drainage groove is formed by a pair of drainage groove wall portions in the guide rail, the drainage groove wall portion close to an inner side in the vehicle width direction in the pair of drainage groove wall portions is provided with an opening or an indentation in a through manner, and the drainage member is inserted into the opening or the indentation.

According to the above structure, the drainage member is inserted into the opening or the indentation of the drainage groove wall portion of the guide rail, and therefore there is no need to increase the space in the up-down direction to accommodate the drainage member, thereby suppressing the overall height of the sunroof device.

In addition, in the present disclosure, preferably, a lower edge of the opening is inclined in a manner in which the lower edge of the opening is located downward as getting closer to the guide rail drainage groove side, and a bottom wall of the drainage member has a first portion and a second portion arranged sequentially from an outer side to an inner side in the vehicle width direction, and when the drainage member is installed on the guide rail, at least a top end of the first portion abuts against the lower edge of the opening, and the first portion is inclined in a manner in which the first portion is located downward as getting closer to the guide rail drainage groove side.

According to the above structure, the first portion of the bottom wall of the drainage member is inclined in a manner in which the first portion is located downward as getting closer to the guide rail drainage groove side, and is inserted into the opening at the lower edge which is inclined in the same manner. Thus, water flowing out of the panel drainage component can be guided to flow smoothly into the guide rail drainage groove, and the water flow speed can be increased to increase the drainage volume.

Additionally, in the present disclosure, preferably, the second portion of the bottom wall is formed to be inclined in a manner in which the second portion is located downward as getting closer to the guide rail drainage groove side when the drainage member is installed on the guide rail.

According to the above structure, the water flowing out of the panel drainage component can be further guided to flow smoothly into the guide rail drainage groove without being retained in the drainage member.

In addition, in the present disclosure, preferably, an inclination angle of the first portion relative to a horizontal direction is greater than an inclination angle of the second portion relative to a horizontal direction.

According to the above structure, the water flow speed can be further increased by the second portion, and the water can be discharged more smoothly into the guide rail drainage groove.

In addition, in the present disclosure, preferably, a notch portion into which the drainage member is embedded is formed in a wall portion that is located on the inner side in the vehicle width direction relative to the pair of drainage groove wall portions in the guide rail.

According to the above structure, because the notch portion into which the drainage member is embedded is formed, there is no need to arrange space for placing the drainage member above the guide rail, so that the overall height of the sunroof device can be suppressed.

In addition, in the present disclosure, preferably, the drainage member has a pair of side walls extending in the vehicle width direction and standing upward from the bottom wall on both sides in the front-rear direction, and protrusions are respectively provided on the pair of side walls, when the drainage member is installed on the guide rail, the pair of side walls abut against the drainage groove wall portion provided with the opening or the indentation from the inner side in the vehicle width direction, and the protrusion engages with the wall portion in the guide rail in which the notch portion is formed from the outer side in the vehicle width direction, so that the drainage member is fixed to the guide rail.

According to the above structure, the movement of the drainage member in the vehicle width direction is restricted by the drainage groove wall portion and the wall portion of the guide rail, so that the drainage member can be stably fixed to the guide rail of the sunroof device. Moreover, by such a simple structure as the engagement, the installation of the drainage member can be facilitated. Moreover, by providing a pair of side walls, the drainage member can prevent water flowing into the drainage member from intruding into the interior of the vehicle from both sides in the front-rear direction.

In addition, in the present disclosure, preferably, on an inner side of the second portion of the bottom wall in the vehicle width direction, there is a base end side wall extending in the front-rear direction and standing upward from the second portion, and when the drainage member is installed on the guide rail, the base end side wall is located on the inner side in the vehicle width direction relative to the two end portions in the vehicle width direction of the panel drainage component.

According to the above structure, the drainage member is provided in a drawer shape having a base end side wall and two side walls, so that the water flowing into the drainage component can be more reliably prevented from intruding into the interior of the vehicle.

In addition, in the present disclosure, preferably, the sunroof device has a sunroof panel, the sunroof panel covers the sunroof opening and comprises a front panel and a rear panel arranged in the front-rear direction, and at least one of the front panel and the rear panel can slide by guiding by the pair of guide rails, and the panel drainage component is located between the front panel and the rear panel.

In addition, in the present disclosure, preferably, the guide rail drainage groove also serves as a sliding groove for a sliding of a slider of at least one of the front panel and the rear panel.

According to the above structure, the cross-sectional shape of the guide rail can be further simplified, the dimension of the guide rail in the width direction can be reduced, and the area of the sunroof opening can be increased.

### BRIEF DESCRIPTION OF DRAWINGS

FIG. 1 is a schematic diagram of a sunroof device disclosed the present disclosure.

FIG. 2 is a partial stereoscopic diagram of the A portion of FIG. 1.

FIG. 3 is a schematic diagram for illustrating the installation of a drainage member on a guide rail.

FIG. 4 is a cross-sectional view taken along the B-B line of FIG. 2.

### DETAILED DESCRIPTION

Hereinafter, the preferred embodiment of the present disclosure is described with reference to the accompanying drawings. In the following description, the direction extending along the front and rear of the vehicle is referred to as the front-rear direction X, the direction along the width of the vehicle is referred to as the vehicle width direction Y, and the direction along the up and down of the vehicle is referred to as the up-down direction Z.

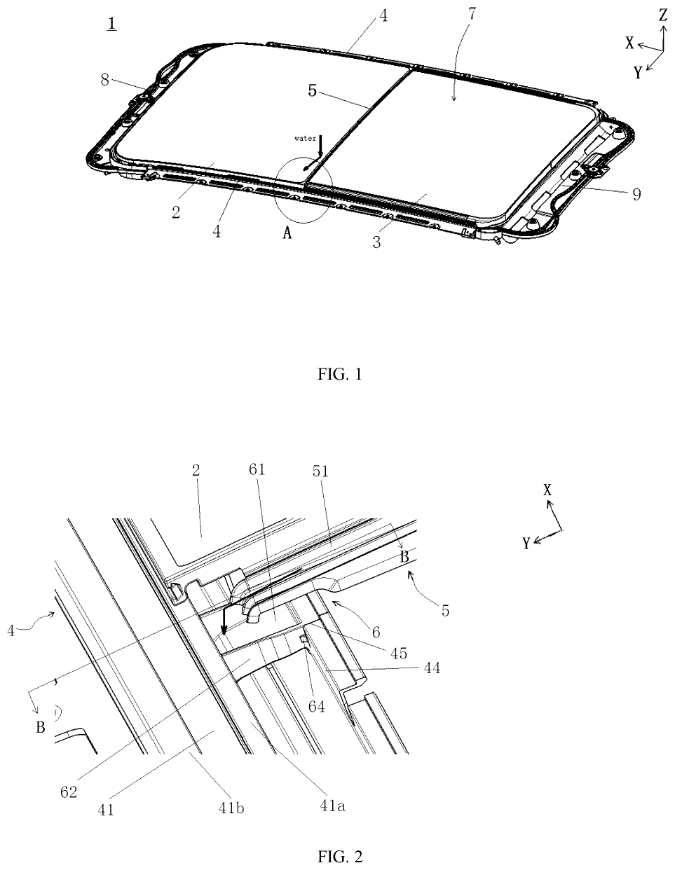

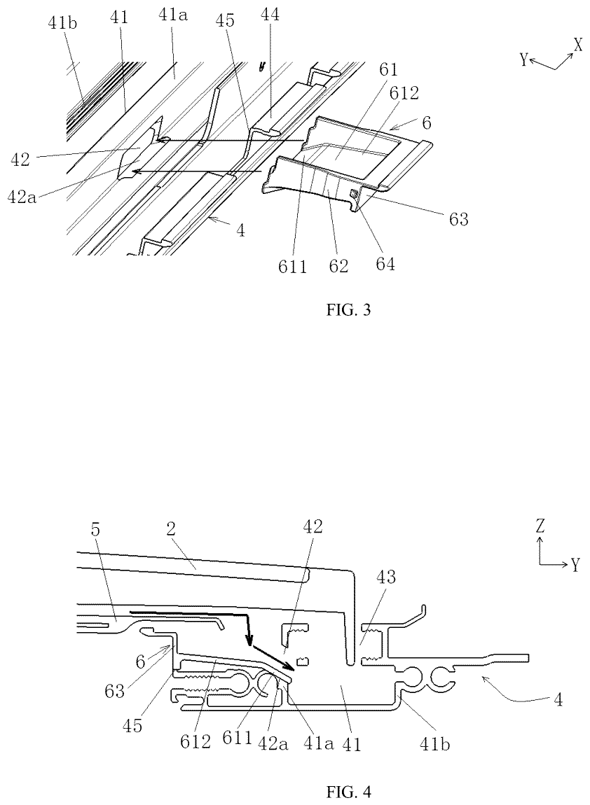

FIG. 1 is a schematic diagram of a sunroof device disclosed in the present disclosure. FIG. 2 shows a structure near a drainage member of the sunroof device in the A portion of FIG. 1. FIG. 3 is a schematic diagram for illustrating the installation of a drainage member on a guide rail. FIG. 4 is a cross-sectional view taken along the B-B line of FIG. 2. In FIGS. 2 to 4, for the sake of clarity, only the structure on one side of the sunroof device in the vehicle width direction Y is shown, and as the structure on the other side is similar to the one side, the illustration is omitted.

A sunroof device 1 is installed on the roof of the vehicle. As shown in FIG. 1, the sunroof device 1 has a front panel 2, a rear panel 3, a pair of guide rails 4, a panel drainage component 5, a pair of drainage members 6 (referring to FIG. 2), a front frame 8, and a rear frame 9. Here, the part surrounded by the pair of guide rails 4, the front frame 8, and the rear frame 9 is a sunroof opening 7 of the sunroof device 1.

The front panel 2 and the rear panel 3 cover the sunroof opening 7 of the sunroof device 1 and are arranged in the front-rear direction X. The front panel 2 and the rear panel 3 each have a roughly rectangular shape, for example, when viewed from above. In addition, at least one of the front panel 2 and the rear panel 3 may be light-transmissive, for example, may completely transmit light, or may selectively transmit part of the light, and may also have the function of blocking ultraviolet rays. In addition, the front panel 2 and the rear panel 3 may be made of any known panel material, such as glass, etc.

In addition, the front panel 2 and the rear panel 3 can slide in the front-rear direction X of the vehicle respectively along with the movement of the slider (not shown) connected thereto. However, the setting of the front panel 2 and the rear panel 3 is not limited thereto. Alternatively, one of the front panel 2 and the rear panel 3 can move in the front-rear direction X of the vehicle along with the movement of the slider connected thereto, while the other is a fixed panel that cannot move. Alternatively, one of the front panel 2 and the rear panel 3 slides and moves in the front-rear direction X of the vehicle in conjunction with the other.

As shown in FIGS. 2 to 4, a pair of guide rails 4 can be made of metals such as aluminum and aluminum alloy, but the material of the guide rail is not limited thereto. As long as the function required by the guide rail can be achieved, the material of the guide rail is not particularly limited. A pair of guide rails 4 extend along the front-rear direction X of the vehicle and are respectively arranged on both sides of the sunroof opening 7 in the vehicle width direction Y. A pair of guide rails 4 guide at least one of the front panel 2 and the rear panel 3 to move in the front-rear direction X. Specifically, a pair of guide rails 4 are respectively provided with a sliding groove 43, and a slider of at least one of the front panel 2 and the rear panel 3 slides in the sliding groove 43, thereby guiding at least one of the front panel 2 and the rear panel 3 to move in the front-rear direction X. In addition, each guide rail 4 is provided with only one guide rail drainage groove 41 extending along the front-rear direction X, and the guide rail drainage groove 41 discharges water intruding from the sunroof device 1 into the vehicle interior to the outside of the vehicle. The guide rail drainage groove 41 is formed by a pair of drainage groove wall portions 41a and 41b in the guide rail 4. In this embodiment, the guide rail drainage groove 41 also serves as a sliding groove 43 for a sliding of a slider of the front panel 2 and the rear panel 3. However, in other embodiments, the guide rail drainage groove and the sliding groove may be provided separately.

In addition, as shown in FIGS. 3 and 4, an opening 42 is provided in a through manner in the drainage groove wall portion 41a close to an inner side of the vehicle width direction Y in the pair of drainage groove wall portions 41a and 41b, and the opening 42 is provided for the drainage member 6 to be inserted. The opening 42 can be formed, for example, by beveling the drainage groove wall portion 41a. The lower edge 42a of the opening 42 is inclined in a manner in which the lower edge 42a is located downward as getting closer to the guide rail drainage groove 41 side. Here, the lower edge 42a of the opening 42 does not strictly refer to the lower edge of the opening on the drainage groove wall portion 41a, but also includes a portion on the same inclined surface that is formed near the drainage groove wall portion 41a by the same cutting process, etc. and is connected to the lower edge of the drainage groove wall portion 41a.

In addition, a notch portion 45 into which the drainage member 6 is embedded is formed in a wall portion 44 of the guide rail 4 located on an inner side in the vehicle width direction Y relative to the pair of drainage groove wall portions 41a and 41b.

As shown in FIGS. 1 and 2, the panel drainage component 5 is located between the front panel 2 and the rear panel 3, extends in the vehicle width direction Y, and traverses the sunroof opening 7. The panel drainage component 5 is a component for draining water from between the front panel 2 and the rear panel 3 to the guide rail 4. A panel drainage groove 51 extending in the vehicle width direction Y is provided in the panel drainage component 5. As shown by the arrows in FIGS. 1 and 2, water flows into the panel drainage component 5 from above and then flows outward the vehicle width direction Y along the panel drainage component 5.

As shown in FIGS. 2 and 4, a pair of drainage components 6 are respectively mounted on a pair of guide rails 4. The pair of drainage components 6 are respectively located below two end portions of the panel drainage component 5 in the vehicle width direction Y. In the front-rear direction X of the vehicle, the pair of drainage components 6 and the two end portions of the panel drainage component 5 in the vehicle width direction Y are respectively located at approximately the same position. The drainage member 6 is configured such that water flowing out of the panel drainage groove 51 of the panel drainage component 5 is guided into the guide rail drainage groove 41 of the guide rail 4 through the drainage member 6 as shown by the arrows in FIGS. 2 and 4.

As shown in FIGS. 3 and 4, the drainage member 6 is in a drawer shape, comprising: a bottom wall 61 that is inclined in a manner in which the bottom wall 61 is located downward as getting closer to the guide rail drainage groove 41 side when the drainage member 6 is installed on the guide rail 4; a pair of side walls 62 that stand upward from the bottom wall 61 and extend in the vehicle width direction Y on both sides in the front-rear direction X of the drainage member 6; and a base end side wall 63, where the base end side wall 63 stands upward from the bottom wall 61 and extends in the front-rear direction X on an inner side of the bottom wall 61 in the vehicle width direction Y.

The bottom wall 61 of the drainage member 6 has a first portion 611 and a second portion 612 in sequence from an outer side to an inner side in the vehicle width direction Y. When the drainage member 6 is installed on the guide rail 4, a top of the first portion 611 abuts against the lower edge 42a of the opening 42, and the first portion 611 is inclined in a manner that the first portion 611 is located downward as getting closer to the guide rail drainage groove 41 side, and the second portion 612 is inclined in a manner that the second portion 612 is located downward as getting closer to the guide rail drainage groove 41 side. An inclination angle of the first portion 611 relative to a horizontal direction is greater than an inclination angle of the second portion 612 relative to a horizontal direction.

A protrusion 64 is respectively provided at a position close to the base end side wall 63 of the pair of side walls 62, and the protrusion 64 is used to engage with the wall portion 44 of the guide rail 4 to fix the drainage member 6 to the guide rail 4. However, the setting position of the protrusion 64 is not limited to the above position of the side wall 62, and the protrusion 64 can be provided at any appropriate position of the side wall 62 as long as the drainage member 6 can be stably fixed to the guide rail 4.

The base end side wall 63 stands upward from the second portion 612 of the bottom wall 61 and extends along the front-rear direction X. When the drainage member 6 is installed on the guide rail 4, the base end side wall 63 is located on the inner side of the vehicle width direction Y relative to the two end portions of the panel drainage component 5 in the vehicle width direction Y.

Next, the installation of the drainage member 6 to the guide rail 4 is described. The drainage member 6 is embedded into the notch portion 45 of the wall portion 44 of the guide rail 4 from the inner side in the vehicle width direction Y, and then the notch portion 45 is used to guide the drainage member 6 to move to the outer side in the vehicle width direction Y as shown by the arrow in FIG. 3, and the side of the drainage member 6 opposite to the base end side wall 63 is inserted into the opening 42 on the drainage groove wall portion 41a of the guide rail 4, until the first portion 611 of the bottom wall 61 of the drainage member 6 is supported on the lower edge 42a of the opening 42 and the pair of side walls 62 abut against the drainage groove wall portion 41a from the inner side in the vehicle width direction Y, and the protrusion 64 provided on the side wall 62 of the drainage member 6 passes over the notch portion 45 and engages with the wall 44 of the guide rail 4 from the outer side in the vehicle width direction Y. Thus, the installation of the drainage member 6 to the guide rail 4 is completed.

The effects of this embodiment are described below.

According to the structure of the sunroof device of the present disclosure described above, only one guide rail drainage groove 41 is provided on the guide rail 4, and water flowing out of the panel drainage groove 51 of the panel drainage component 5 is guided into the above guide rail drainage groove 41 via the separately provided drainage member 6, so that drainage of the guide rail and drainage of the sunroof panel are achieved at the same time. Compared with a case in which two drainage grooves, namely, a drainage groove for guide rail drainage and a drainage groove for panel drainage for receiving water from the panel drainage component, are provided on the guide rail, the cross-sectional structure of the guide rail can be simplified, the dimension of the guide rail in the vehicle width direction can be reduced, and the manufacturing cost of the guide rail can be reduced, the area of the sunroof opening can be increased, so that the commercial quality of the sunroof device is improved.

In addition, in this embodiment, the opening 42 is provided in a through manner in the drainage groove wall portion 41a close to the inner side in the vehicle width direction Y, and the drainage member 6 is inserted into the opening 42. Therefore, there is no need to increase the space in the up-down direction Z to accommodate the drainage member 6, so that the overall height of the sunroof device 1 is suppressed.

In addition, in this embodiment, the lower edge 42a of the opening 42 is inclined in a manner in which the lower edge 42a is located downward as getting closer to the guide rail drainage groove 41 side, and the first portion 611 of the bottom wall 61 of the drainage member 6 that abuts against the lower edge 42a of the opening 42 is also inclined in a manner in which the first portion 611 is located downward as getting closer to the guide rail drainage groove 41 side when the drainage member 6 is installed on the guide rail 4.

Therefore, the water flowing out of the panel drainage component 5 can be guided to flow smoothly into the guide rail drainage groove 41, and the water flow speed can be increased to increase the drainage amount.

In addition, in this embodiment, the second portion 612 of the bottom wall 61 is formed to be inclined in a manner that the second portion 612 is located downward as getting closer to the guide rail drainage groove 41 side when the drainage member 6 is installed on the guide rail 4. Thus, the water flowing out of the panel drainage component 5 can be further guided to flow smoothly into the guide rail drainage groove 41 without being retained in the drainage member 6.

In addition, in this embodiment, the inclination angle of the first portion 611 relative to the horizontal direction is greater than the inclination angle of the second portion 612 relative to the horizontal direction. Thus, the water flow speed can be further increased by the second portion 612, and water can be discharged more smoothly into the guide rail drainage groove 41.

In addition, in this embodiment, a notch portion 45 into which the drainage member 6 is embedded is formed in the wall portion 44 of the guide rail 4, and therefore there is no need to arrange space for placing the drainage member 6 above the guide rail 4, so that the overall height of the sunroof device 1 can be suppressed.

In addition, in this embodiment, the drainage member 6 has a pair of side walls 62 extending along the vehicle width direction Y and standing upward from the bottom wall 61 on both sides in the front-rear direction X, and the pair of side walls 62 are respectively provided with protrusions 64 that engage with the wall portion 44 of the guide rail 4.

Thus, the movement of the drainage member 6 in the vehicle width direction Y is restricted by the drainage groove wall portion 41a and the wall portion 44 of the guide rail 4, so that the drainage member 6 can be stably fixed to the guide rail 4 of the sunroof device 1. Moreover, by such a simple structure as engagement, the installation of the drainage member 6 can be facilitated. Furthermore, the drainage member 6 can prevent water flowing into the drainage member 6 from intruding into the interior of the vehicle from both sides in the front-rear direction X by providing a pair of side walls 62.

In addition, in this embodiment, the drainage member 6 has a base end side wall 63 extending in the front-rear direction X and standing upward from the second portion 612 on an inner side of the second portion 612 of the bottom wall 61 in the vehicle width direction Y, and when the drainage member 6 is installed on the guide rail 4, the base end side wall 63 is located on the inner side in the vehicle width direction Y relative to the two end portions of the panel drainage component 5 in the vehicle width direction Y. Thus, the drainage member 6 is provided in a drawer shape having the base end side wall 63 and two side walls 62, so that water flowing into the drainage member 6 can be more reliably prevented from intruding into the interior of the vehicle.

In addition, in this embodiment, the guide rail drainage groove 41 also serves as a sliding groove 43 for a sliding of a slider of at least one of the front panel 2 and the rear panel 3. Thus, the cross-sectional shape of the guide rail 4 can be further simplified, the dimension of the guide rail 4 in the width direction can be reduced, and the area of the sunroof opening can be increased.

The preferred embodiment of the present disclosure has been described above, but is not limited thereto. Various changes can be made as follows.

In the above preferred embodiment, the drainage member 6 is inserted into the opening 42 of the drainage groove wall portion 41a and is embedded in the notch portion 45 on the wall portion 44 of the guide rail 4. However, as long as the drainage member 6 can guide the water of the panel drainage component 5 into the guide rail drainage groove 41 of the guide rail 4, the drainage member 6 can also be installed in other ways. For example, the drainage member spans across the guide rail 4. In this case, there is no need to provide the opening 42 and the notch portion 45 on each wall portion of the guide rail.

In the above preferred embodiment, the opening 42 into which the drainage member 6 is inserted is provided in the drainage groove wall portion 41a in a through manner, but the configuration is not limited to thereto. Under the premise of not affecting the guide rail 4 to guide the movement of the sunroof panel, an indentation opening upward can also be provided in the drainage groove wall portion 41a for the insertion of the drainage member 6.

In the above preferred embodiment, the bottom wall 61 of the drainage member 6 is formed as a whole to be inclined in a manner that the drainage member 6 is located downward as getting closer to the guide rail drainage groove 41 side when the drainage member 6 is installed on the guide rail 4, the drainage member 6. However, the arrangement of the bottom wall 61 of the drainage member 6 is not limited to the above manner. For example, the bottom wall 61 may be arranged horizontally as a whole, or one of the first portion 611 and the second portion 612 of the bottom wall 61 may be arranged horizontally, and the other may be inclined in a manner that the other is located downward as getting closer to the guide rail drainage groove 41 side. In addition, in the above preferred embodiment, the inclination angle of the first portion 611 is greater than the inclination angle of the second portion 612, but the setting of the inclination angle is not limited thereto. For example, the inclination angle of the first portion 611 may be the same as the inclination angle of the second portion 612, or may be smaller than the inclination angle of the second portion 612. In addition, the inclination angle of the first portion 611 is preferably the same as the inclination angle of the lower edge 42a, but the setting of the inclination angle is not limited thereto. As long as the first portion 611 can abut against the lower edge 42a, the inclination angles of the two are not particularly limited.

Here, in the above preferred embodiment, a top end of the first portion 611 abuts against the lower edge 42a of the opening 42, and the first portion 611 may also extend more into the guide rail drainage groove 41 as long as the drainage of the guide rail drainage groove 41 is not hindered.

In the above preferred embodiment, the drainage member 6 is formed into a drawer shape having a base end side wall 63 and a pair of side walls 62 that stand upward from the bottom wall 61, but the shape of the drainage member 6 is not particularly limited as long as water flowing from the panel drainage component 5 into the drainage member 6 can be prevented from intruding into the interior of the vehicle. For example, as long as the inclination angle of the bottom wall 61 is large enough, there is no need to provide a base end side wall for preventing water from intruding into the interior of the vehicle.

In addition, in the above preferred embodiment, the protrusion 64 provided on the side wall 62 of the drainage member 6 is engaged with the wall portion 44 formed with the notch portion 45 in the guide rail 4, so that the drainage member 6 is fixed to the guide rail 4. However, the fixing method of the drainage member 6 and the guide rail is not limited to this, for example, threaded holes can be provided on both the guide rail and the drainage member, and the two can be fixed by threaded members such as screws.

In addition, in the above preferred embodiment, a case in which the panel drainage component 5 is located between the front panel 2 and the rear panel 3 is described. However, the location of the panel drainage component 5 is not limited to thereto. The panel drainage component 5 can also be provided between the front panel 2 and the front frame 8, and/or the rear panel 3 and the rear frame 9. In the case of having only one sunroof panel, the panel drainage component 5 can be located between the sunroof panel and either the front frame or the rear frame.

The above describes the embodiment of the present disclosure. However, the present disclosure is not limited to the above embodiment. Without departing from the main purpose of the present disclosure, the embodiment obtained by the person skilled in the art by making appropriate changes, combinations and deletions to the above components is also included in the technical scope to be protected by the present disclosure.

### DESCRIPTION OF SYMBOLS

1 Sunroof device
2 Front panel
3 Rear panel
4 Guide rail
5 Panel drainage component
6 Drainage member
7 Sunroof opening
8 Front frame
9 Rear frame
41 Guide rail drainage groove
41a, 41b Drainage groove wall portion
42 Opening
42a Lower edge
43 Sliding groove
44 Wall portion
45 Notch portion
51 Panel drainage groove
61 Bottom wall
611 First portion
612 Second portion
62 Side wall
63 Base end side wall
64 Protrusion.

What is claimed is:

1. A sunroof device, comprising:
a pair of guide rails, which extend along a front-rear direction of a vehicle and are respectively arranged on both sides of a sunroof opening in a vehicle width direction;
a panel drainage component, which extends in the vehicle width direction, and traverses the sunroof opening; and
a pair of drainage members, which are respectively mounted on the pair of guide rails, and are respectively located below two end portions of the panel drainage component in the vehicle width direction, wherein
the panel drainage component is provided with a panel drainage groove extending in the vehicle width direction, and each of the guide rails is provided with only one guide rail drainage groove extending in the front-rear direction, and
the drainage member is configured such that water flowing out of the panel drainage groove is guided into the guide rail drainage groove via the drainage member.

2. The sunroof device according to claim 1, wherein
the guide rail drainage groove is formed by a pair of drainage groove wall portions in the guide rail,
the drainage groove wall portion close to an inner side in the vehicle width direction in the pair of drainage groove wall portions is provided with an opening or an indentation in a through manner, and
the drainage member is inserted into the opening or the indentation.

3. The sunroof device according to claim 2, wherein
a lower edge of the opening is inclined in a manner in which the lower edge of the opening is located downward as getting closer to the guide rail drainage groove side, and
a bottom wall of the drainage member has a first portion and a second portion arranged sequentially from an outer side to an inner side in the vehicle width direction, and when the drainage member is installed on the guide rail, at least a top end of the first portion abuts against the lower edge of the opening, and the first portion is inclined in a manner in which the first portion is located downward as getting closer to the guide rail drainage groove side.

4. The sunroof device according to claim 3, wherein
the second portion of the bottom wall is formed to be inclined in a manner in which the second portion is located downward as getting closer to the guide rail drainage groove side when the drainage member is installed on the guide rail.

5. The sunroof device according to claim 4, wherein
an inclination angle of the first portion relative to a horizontal direction is greater than an inclination angle of the second portion relative to a horizontal direction.

6. The sunroof device according to claim 4, wherein
a notch portion into which the drainage member is embedded is formed in a wall portion that is located on the inner side in the vehicle width direction relative to the pair of drainage groove wall portions in the guide rail.

7. The sunroof device according to claim 6, wherein
the drainage member has a pair of side walls extending in the vehicle width direction and standing upward from the bottom wall on both sides in the front-rear direction, and protrusions are respectively provided on the pair of side walls, when the drainage member is installed on the guide rail, the pair of side walls abut against the drainage groove wall portion provided with the opening or the indentation from the inner side in the vehicle width direction, and the protrusion engages with the wall portion in the guide rail in which the notch portion is formed from the outer side in the vehicle width direction, so that the drainage member is fixed to the guide rail.

8. The sunroof device according to claim 7, wherein
on an inner side of the second portion of the bottom wall in the vehicle width direction, there is a base end side wall extending in the front-rear direction and standing upward from the second portion, and when the drainage member is installed on the guide rail, the base end side wall is located on the inner side in the vehicle width direction relative to the two end portions in the vehicle width direction of the panel drainage component.

9. The sunroof device according to claim 1, wherein
the sunroof device has a sunroof panel, the sunroof panel covers the sunroof opening and comprises a front panel and a rear panel arranged in the front-rear direction, and at least one of the front panel and the rear panel can slide by guiding by the pair of guide rails, and
the panel drainage component is located between the front panel and the rear panel.

10. The sunroof device according to claim 9, wherein
the guide rail drainage groove also serves as a sliding groove for a sliding of a slider of at least one of the front panel and the rear panel.
